(19) United States
(12) Patent Application Publication
(10) Pub. No.: US 2026/0022977 A1
(43) Pub. Date: Jan. 22, 2026

(54) CMOS TEMPERATURE COMPENSATOR AND SENSING METHOD THEREOF

(71) Applicant: Ming-Chou YEN, Nantou City (TW)

(72) Inventor: Ming-Chou YEN, Nantou City (TW)

(21) Appl. No.: 19/206,094

(22) Filed: May 13, 2025

(30) Foreign Application Priority Data
Jul. 22, 2024 (TW) 113127332

(51) Int. Cl. G01K 7/42; G01K 7/01

(52) U.S. Cl. CPC G01K 7/42; G01K 7/01

(57) ABSTRACT

Disclosed are a CMOS temperature compensator and its sensing method. The CMOS temperature compensator consists of multiple constant current source modules, a bias control module, a first voltage module, a sampling control module, a second transistor, a second voltage module, a temperature detection module and a processing module. The constant current source modules have a terminal connected to the first voltage module and another terminal connected to the second transistor and the temperature detection module. The processing module is connected to the temperature detection module and the sampling control module. The temperature detection module detects a second working voltage value of the second transistor according to the sensing method of CMOS temperature compensator, and converts it into first and second reference voltage values to obtain a temperature correction voltage value in order to correct the measured temperature, thereby reducing the mismatch problem and increasing the accuracy of temperature measurement.

### BACKGROUND OF THE DISCLOSURE

### Technical Field

The present disclosure generally relates to the field of temperature sensing technologies, and particularly relates to a CMOS temperature compensator and its sensing method for reducing the influence of process.

### Description of the Related Art

Transistor is a key component commonly used in digital or analog circuits. The conducting (ON) state or cut-off (OFF) state of the transistor is controlled by applying voltage to the gate terminal of the transistor. Through different voltages applied to the gate, the current flowing between the source and drain of the transistor can be controlled. Especially, in digital circuits, the CMOS transistor can be used as a switching component by setting its ON or OFF state, or can be used to measure temperature by means of the different current flows.

With the advancement of modern semiconductor process technology, various electronic products are designed with easy portability, and the same also applies to the development of temperature sensors; however, most of the common temperature sensing circuits utilize the current difference between the current mirrors for temperature sensing, and they are susceptible to the impact of CMOS process deviation in circuits or the change of channel lengths, which will result in inaccuracy of the measured temperature. Therefore, how to provide a way to reduce the impact of CMOS process deviation of the thermometer and its sensing method, increase the accuracy of temperature measurement, and reduce the aforementioned drawbacks is really necessary.

### SUMMARY OF THE DISCLOSURE

The primary objective of the present disclosure is to provide a CMOS temperature compensated sensor and its sensing method to reduce the impact of temperature measurement of CMOS temperature sensors due to the deviation in the CMOS process or the change in the length ratio of channels during the manufacturing process, and to improve the accuracy of temperature measurement.

To achieve the above objective, the present disclosure provides a CMOS temperature compensator, which includes a plurality of constant current source modules, a bias control module, a first voltage module, a sampling control module, a second transistor, a second voltage module, a temperature detection module and a processing module. Each of the constant current source modules includes a first transistor and a first switch unit connected in series; the bias control module is respectively and electrically connected to a terminal of the first transistors; the first voltage module is respectively and electrically connected to another terminal of the first transistors; the sampling control module is respectively and electrically connected to a terminal of the first switch units; the second transistor is electrically connected to another terminal of the first switch units of the constant current source modules; the second voltage module is electrically connected to a terminal of the second transistor; the temperature detection module has a terminal electrically connected to the second transistor and another terminal which is electrically connected to processing module, for detecting a second working voltage value of the second transistor in a working status; and the processing module is respectively and electrically connected to the sampling control module and the temperature detection module, for recording the second working voltage value corresponding to each constant current source module and includes an output terminal; wherein the processing module detects and averages the second working voltage value of each constant current source module in a working state as a first mean; the processing module selects a value from the first mean or from the second working voltage value with the smallest difference between the first mean and the second working voltage value, and outputs said value as a first reference voltage value through the temperature detection module; the processing module selects the second working voltage values with the closest difference from the first mean of the m constant current source modules, and calculates the second working voltage value of the m constant current source modules in the working status, and outputs said second working voltage as a second reference voltage value through the temperature detection module; and the processing module calculates a difference between the first reference voltage value and the second reference voltage value as a temperature corrected voltage value.

Further, each first transistor includes a first electrode, a second electrode and a first control electrode, and each first switch unit includes a first input terminal, a first output terminal and a first switching terminal; wherein, the second electrodes of the first transistors are respectively and electrically connected to the first input terminals which are connected in series with the first switch units; the first control electrodes of the first transistors are respectively and electrically connected to the bias control module, and the first electrodes are respectively and electrically connected to the first voltage module; and the first switching terminals of the first switch units are respectively and electrically connected to the sampling control module.

Further, the second transistor includes a third electrode, a fourth electrode and a second control electrode, and the third electrode is electrically connected to the first output terminals of the first switch units of the constant current source modules; the second control electrode and the fourth electrode are electrically connected to the second voltage module.

Further, the temperature detection module has a terminal electrically connected to the third electrode terminal of the second transistor which is electrically connected to the first output terminals of the first switch units, for detecting a second working voltage value between the third electrode and the second control electrode.

Further, the processing module controls the sampling control module, so that the first transistors and the first switch units of constant current source modules which are sequentially conducted with the second transistor, and the processing module controls the temperature detection module to sequentially detect and record the second working voltage value between the third electrode and the second control electrode of second transistor when the first transistors are conducted with the second transistor.

Further, the temperature detection module includes an analog-to-digital conversion unit for converting an analog signal provided by the temperature detection module into the first reference voltage value and the second reference voltage value of a digital signal.

Further, the analog-to-digital conversion unit has a terminal electrically connected to a signal amplifier unit.

Further, a sensing method using the CMOS temperature compensator is processed by the processing module, and the sensing method of the CMOS temperature compensator mainly includes the steps of: detecting a second working voltage value, wherein the processing module controls the sampling control module to set the first transistors and the corresponding first switch units to the conducting state in turn, and when the temperature detection module detects the second working voltage value of the second transistor when each constant current source module is in the working state; calculating a first mean, wherein the processing module averages the second working voltage values corresponding to the constant current source modules in the working state to obtain the first mean; obtaining a first reference voltage value, wherein the processing module calculates the difference between each second working voltage value and the first mean, and selects a value with the smallest difference between the second working voltage value and the first mean or a value with the first mean and outputs said value as the first reference voltage value through the temperature detection module; obtaining a second reference voltage value, wherein the processing module selects the m constant current source modules with a voltage value closest to the first mean according to the difference between each second working voltage value and the first mean, and calculates the second working voltage values of the m constant current source modules in the working state and outputs said values as the second reference voltage value through the temperature detection module; and obtaining a temperature corrected voltage value, wherein the processing module calculates and stores the difference between the first reference voltage value and the second reference voltage value as the temperature corrected voltage value.

Further, the sensing method using the CMOS temperature compensator includes the step of calculating temperature, wherein the processing module drives the temperature detection module to calculate the temperature detected by the second transistor according to the temperature corrected voltage value.

The CMOS temperature compensator and its sensing method of the present disclosure mainly use the constant current source modules to provide the required driving current for the second transistor to detect temperature, and use the temperature detection module to sequentially obtain the second working voltage values of the second transistor when the constant current source modules is at the working state, and the processing module also averages the second working voltage values to obtain the first mean, and then selects a value from the first mean or from the second working voltage value with the smallest difference between the first mean and the second working voltage value, and outputs such value as a first reference voltage value through the temperature detection module, and selects the second working voltage values with the m constant current sources closest difference from the first mean, and calculates the second working voltage value of the m constant current source modules in the working state, and outputs said second working voltage as a second reference voltage value through the temperature detection module, and the processing module finally calculates and stores a difference between the first reference voltage value and the second reference voltage value as a temperature corrected voltage value. In this way, the same second transistor can be used for sensing temperature at different stages to reduce the error of the second transistor caused by the process, and the error caused by the first transistors can be compensated by the temperature corrected voltage value. In this way, the present disclosure is no longer affected by the mismatch problem caused by the process variation, and the drift caused by the variations of package of the first transistors can also be compensated by the above method, thereby obtaining an accurate temperature output and significantly improving the temperature correction efficiency.

### BRIEF DESCRIPTION OF THE DRAWINGS

FIG. 1 is a flow chart of a sensing method of a CMOS temperature compensator of the present disclosure.

FIG. 2 is a circuit block diagram of the sensing method of a CMOS temperature compensator of the present disclosure.

FIG. 3 is a circuit block diagram showing the operation of one of the constant current source modules of a CMOS temperature compensator of the present disclosure in a working state.

FIG. 4-1 is a schematic view showing the operation of obtaining a first reference voltage value by the CMOS temperature compensator of the present disclosure.

FIG. 4-2 is a schematic view showing the operation of obtaining a second reference voltage value by the CMOS temperature compensator of the present disclosure.

FIG. 4-3 is a schematic view showing the operations of measuring temperature and using a temperature corrected voltage value by the CMOS temperature compensator of the present disclosure.

FIG. 5 is a circuit block diagram showing the operation of the CMOS temperature compensator in accordance with another embodiment of the present disclosure.

### DESCRIPTION OF THE PREFERRED EMBODIMENTS

With respect to the technical means and operating method of the present disclosure, several preferred embodiments are described in detail below in conjunction with the drawings to provide a deeper understanding and a better recognition of the present disclosure. In addition, the drawings in the present disclosure are not necessarily drawn to actual proportions for the purpose of illustrating the disclosure, and the proportions in the drawings are not intended to limit the scope of the present invention for which protection is sought.

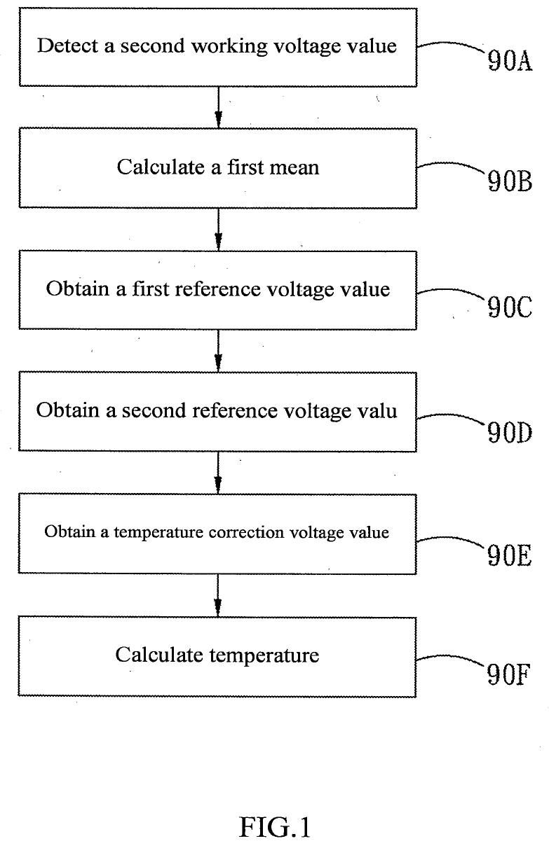

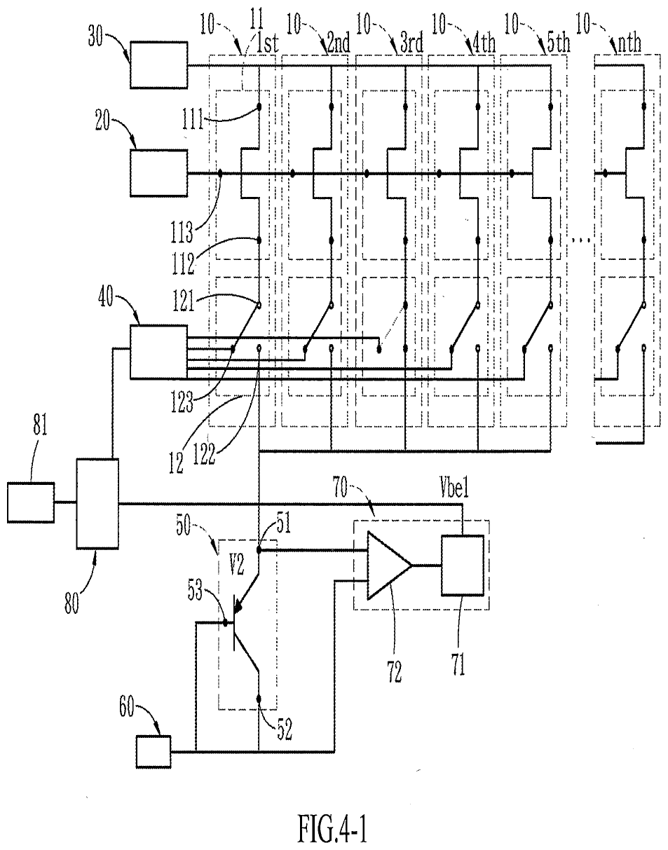

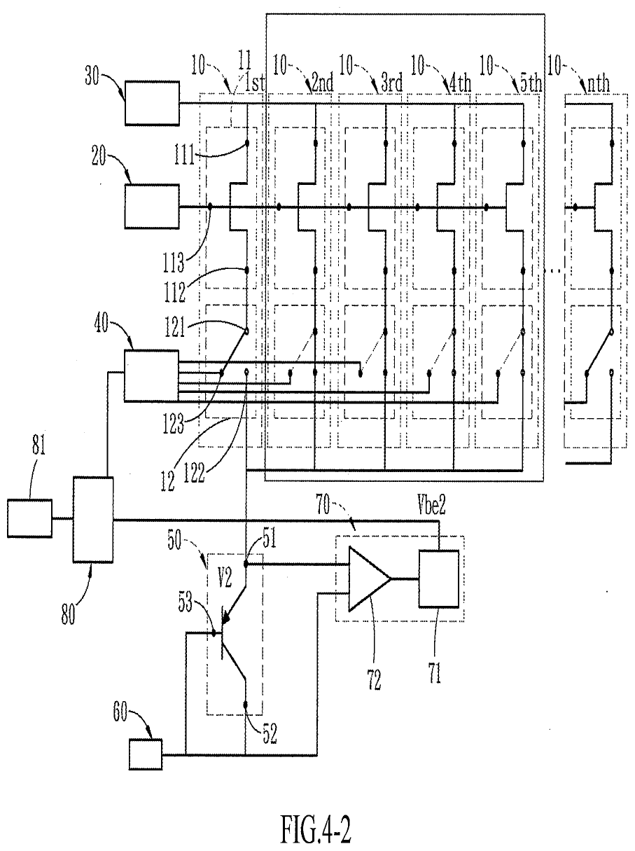

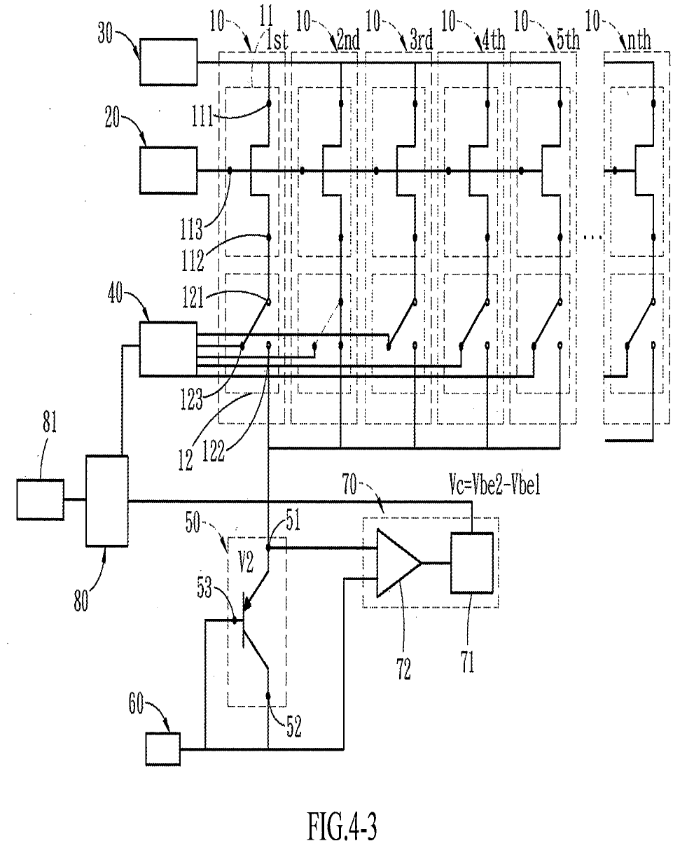

With reference to FIGS. 1 to 5 for the technical characteristics of the present disclosure, the present disclosure provides a CMOS temperature compensator, which includes a plurality of constant current source modules 10, a bias control module 20, a first voltage module 30, a sampling control module 40, a second transistor 50, a second voltage module 60, a temperature detection module 70 and a processing module 80.

Each of the constant current source modules 10 includes a first transistor 11 and a first switch unit 12 connected in series, each first transistor 11 includes a first electrode 111, a second electrode 112 and a first control electrode 113, and each first switch unit 12 includes a first input terminal 121, a first output terminal 122 and a first switching terminal 123. Wherein, the second electrodes 112 of the first transistors 11 are respectively and electrically connected to the serially connected first input terminals 121 of the first switch units.

The bias control module 20 is respectively and electrically connected to the first control electrodes 113 of the first transistors 11. In this embodiment, the bias control module 20 supplies a constant voltage to the electrically connected first control electrodes 113 of the first transistors 11, wherein the constant volage can be generated by a bandgap circuit, but the present disclosure is not limited to this embodiment.

The first voltage module 30 is respectively and electrically connected to the first electrodes 111 of the first transistors 11. In this embodiment, the first voltage module 30 supplies a constant voltage required for the higher electric potential of the first electrodes 111 which are electrically connected to the first transistors 11, but the present disclosure is not limited to this embodiment.

The sampling control module 40 is respectively and electrically connected to the first switching terminals 123 of the first switch units 12.

The second transistor 50 includes a third electrode 51, a fourth electrode 52 and a second control electrode 53, and the third electrode 51 is electrically connected to the first output terminals 122 of the first switch units 12 of the constant current source modules 10.

The second voltage module 60 is electrically connected to the second control electrode 53 and the fourth electrode 52 of the second transistor 50, and the electric potential of the second voltage module 60 is smaller than that of the first voltage module 30. In this embodiment, the electric potential of the second voltage module 60 is equivalent to the zero potential of the ground, but the present disclosure is not limited to this embodiment.

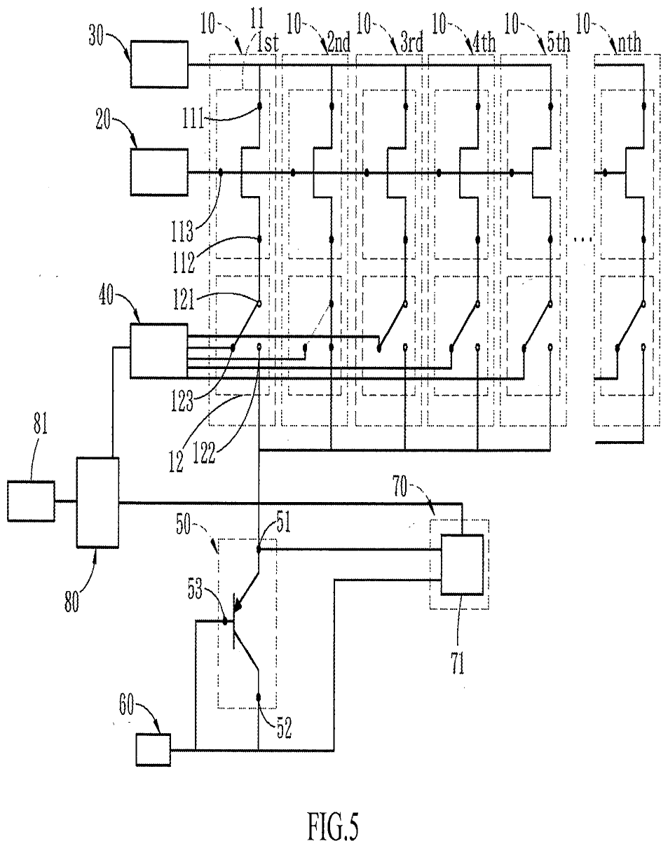

The temperature detection module 70 includes an analog-to-digital conversion unit 71 and a signal amplifier unit 72, the signal amplifier unit 72 has a terminal electrically connected to the second transistor 50's a terminal of the third electrode 51 which is electrically connected to the first output terminals 122 of the first switch units, and another terminal electrically connected to the analog-to-digital conversion unit 71, the temperature detection module 70 is provided for detecting a second working voltage value V2 between the third electrode 51 and the second control electrode 53, and the analog-to-digital conversion unit 71 converts an analog signal transmitted from the input terminal into a digital signal and then outputs the digital signal. As shown in FIG. 5, the temperature detection module 70 may not use the signal amplifier unit 72.

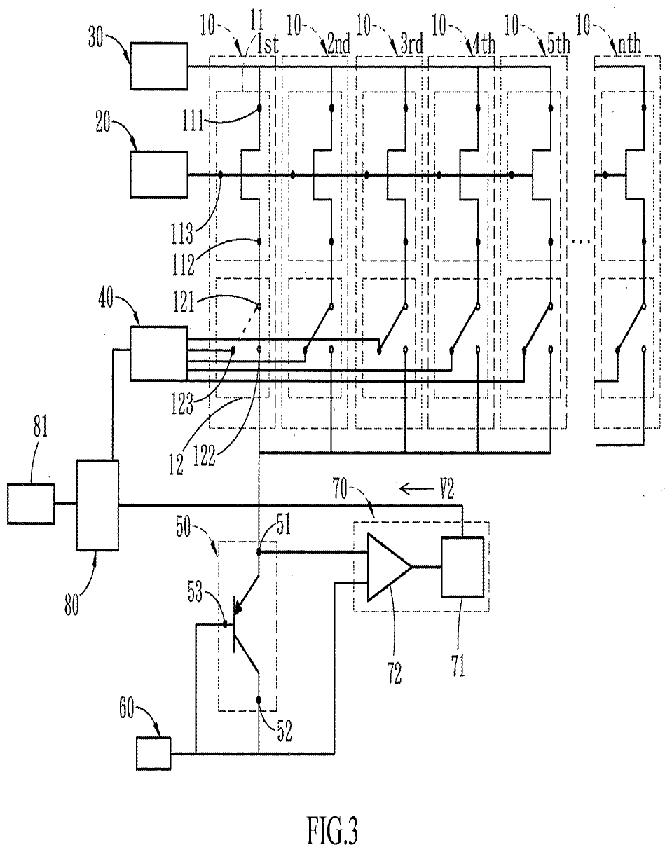

The processing module 80 is respectively and electrically connected to the sampling control module 40 and the temperature detection module 70. As shown in FIG. 3, the processing module 80 electrically connects the first switching terminal 123 of the first switch unit 12 of the constant current source modules 10 to the first input terminal 121 and the first output terminal 122 through the sampling control module 40, such that the first switch unit 12 is in a working state, and records the second working voltage value V2 corresponding to each constant current source module 10, and includes an output terminal 81 provided for outputting a measured temperature value.

Wherein, the processing module 80 enables the temperature detection module 70 to detect the second working voltage value V2 when each constant current source module 10 is in a working state, and averages the second working voltage values V2 corresponding to the constant current source modules 10 as a first mean M1.

Wherein, the processing module selects a value from the first mean or from the second working voltage value V2 of the constant current source module 10 with the smallest difference between the second working voltage values V2 and the first mean M1, and outputs such value as a first reference voltage value Vbe1 through the temperature detection module 70. In this embodiment, the second working voltage value V2 of the constant current source module 10 with the smallest difference between the second working voltage values V2 and the first mean M1 is selected, and outputted as the first reference voltage value Vbe1 through the temperature detection module 70.

Wherein, the processing module 80 then selects the m constant current source modules 10 with the closest difference between the second working voltage values V2 and the first mean M1, calculates the second working voltage values V2 of the m constant current source modules 10 in the working state, and outputs such value as a second reference voltage value Vbe2 through the temperature detection module 70.

Wherein, the processing module 80 calculates the difference between the first reference voltage value Vbe1 and the second reference voltage value Vbe2 as a temperature corrected voltage value Vc. When calculating the temperature, the processing module 80 combines the temperature corrected voltage value Vc with the temperature characteristic presented by the second transistor 50, and then outputs the result as a measured temperature value after calculation.

The processing module 80 of the CMOS temperature compensator implemented with stored program or the hardware of the sensing method of the CMOS temperature compensator, and the sensing method of the CMOS temperature compensator mainly includes the steps of:

Detecting the second working voltage value 90A, wherein the processing module 80 controls the sampling control module 40 to sequentially conduct the first transistors 11 and the first switch units 12 of the constant current source modules 10 which are electrically connected to the second transistor 50, and the processing module 80 also controls the temperature detection module 70 to sequentially detect and record the second working voltage value V2 between the third electrode 51 and the second control electrode 53 of second transistor 50 when the first transistors 11 are conducted with the second transistor 50;

Calculating the first mean 90B, wherein the processing module 80 averages the second working voltage values V2 corresponding to the constant current source modules 10 in the working state to obtain the first mean M1;

Obtaining a first reference voltage value 90C, wherein the processing module 80 calculates the difference between each second working voltage value V2 and the first mean M1, and the second working voltage value V2 of the constant current source module 10 with the smallest difference between the second working voltage values V2 and the first mean M1 is outputted as the first reference voltage value Vbe1 through the temperature detection module 70 or the first mean MI is used as the first reference voltage value Vbe1;
obtaining a second reference voltage value 90D, wherein the processing module 80 selects the m constant current source modules 10 with a voltage closest to the first mean M1 according to the difference between each second working voltage value V2 and the first mean M1, and calculates the second working voltage values V2 of the m constant current source modules 10 in a working state and outputs such value as the second reference voltage value Vbe2 through the temperature detection module, and the number of the m constant current source modules 10 is selected for calculating the second reference voltage value Vbe2 which is smaller than or equal to the number of all the constant current source modules 10, and this embodiment includes one of the constant current source modules 10 selected for the first reference voltage value Vbe1, but the present disclosure is not limited thereto;
obtaining a temperature corrected voltage value 90E, wherein the processing module 80 calculates and stores the difference between the first reference voltage value Vbe1 and the second reference voltage value Vbe2 as the temperature corrected voltage value Vc; and
calculating temperature 90F, wherein the processing module 80 drives the temperature detection module 70 to calculate the temperature detected by the second transistor 50 according to the temperature corrected voltage value Vc.

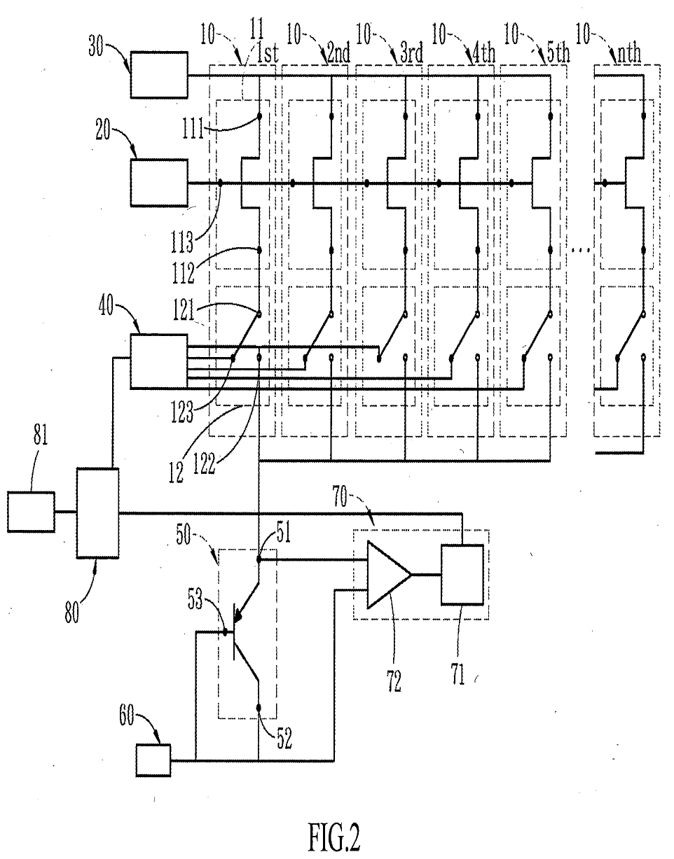

In FIGS. 1 and 2, the processing module 80 of the present disclosure first carries out the step of detecting the second working voltage value 90A, in which each constant current source module 10 is set to the working state by controlling the sampling control module 40 in turn and can be electrically serially connected to the second transistor 50. Then, the temperature detection module 70 detects and records the first transistors 11 and the first switch units 12 of the constant current source module 10 in a working state, and measures the second working voltage values V2 of the second transistor 50. In the step of calculating the first mean 90B, when all of the first transistors 11 and the first switch units 12 in the working state are selected, the first mean M1 is obtained by averaging the second working voltage values V2 measured by the corresponding second transistor 50. Then, the one with the smallest difference between the second working voltage values V2 and the first mean M1 is selected, and the second working voltage value V2 of the constant current source module 10 with the smallest difference is outputted as the first reference voltage value Vbe1 through the temperature detection module 70, or the first mean M1 is used as the first reference voltage value Vbe1. The processing module 80 then selects the m constant current source modules 10 with the closest difference between the second working voltage values V2 and the first mean M1, and calculates the second working voltage value V2 of the m constant current source modules 10 as the second reference voltage value Vbe2 which is outputted through the temperature detection module 70, and the processing module 80 calculates and stores the difference between the first reference voltage value Vbe1 and the second reference voltage value Vbe2 as the temperature corrected voltage value Vc. Therefore, the processing module 80 drives the temperature detection module 70 to calculate the temperature detected by the second transistor 50 according to the temperature corrected voltage value Vc. In this way, the CMOS temperature compensator and its method of the present disclosure not only eliminates the temperature drift phenomenon caused by process variation of the first transistors 11, the first switch units 12 and the second transistor 50, but also uses the same second transistor 50 for temperature detection, thereby reducing the deviation of the channel length or area on the temperature output.

In summation of the description above, the CMOS temperature compensator and its sensing method of the present disclosure mainly uses the constant current source modules 10 to provide the driving current required by the second transistor 50 to perform temperature detection. Through the temperature detection module 70, the second working voltage values V2 of the second transistor 50 can be sequentially obtained when the constant current source modules 10 are in the working state. The processing module 80 averages the second working voltage values V2 to obtain the first mean M1, and then selects a value from the second working voltage values V2 with the smallest difference from the first mean M1 or from the first mean MI, such that the first reference voltage value Vbe1 can be outputted through the temperature detection module 70, and selects the m constant current source modules 10 with the closest difference between the second working voltage values V2 and the first mean M1 and calculates the second working voltage values V2 of the m constant current source modules 10 as the second reference voltage value Vbe2. The difference between the first reference voltage value Vbe1 and the second reference voltage value Vbe2 calculated and stored by the processing module 80 is a temperature corrected voltage value Vc. Thus, the same second transistor 50 can be used as a temperature sensor in different stages to reduce the error of the second transistor 50 caused by the manufacturing process, and the temperature corrected voltage value Vc can be used to compensate for the error caused by the first transistors 11. In this way, the present disclosure will no longer be affected by the mismatch problem caused by process variation, and the drift caused by the variations of package of the first transistors 11 can also be compensated by the above method, thereby obtaining accurate temperature output and significantly improving the temperature correction efficiency.

What is claimed is:

1. A CMOS temperature compensator, comprising:
a plurality of constant current source modules, each comprising a first transistor and a first switch unit connected in series with the first transistor;
a bias control module, respectively and electrically connected to a terminal of the first transistors;
a first voltage module, respectively and electrically connected to another terminal of the first transistors;
a sampling control module, respectively and electrically connected to a terminal of the first switch units;
a second transistor, electrically connected to another terminal of the first switch units of the constant current source modules;
a second voltage module, electrically connected to a terminal of the second transistor;
a temperature detection module, with a terminal electrically connected to the second transistor and another terminal electrically connected to processing module, for detecting a second working voltage value of the second transistor in a working state; and
a processing module, respectively and electrically connected to the sampling control module and the temperature detection module for recording the second working voltage value corresponding to each constant current source module, and comprising an output terminal;
wherein, the processing module detects and averages the second working voltage value of each constant current source module as a first mean;
the processing module selects a value from the first mean or from the second working voltage value with the smallest difference between the first mean and the second working voltage value, and outputs said value as a first reference voltage value through the temperature detection module.
the processing module selects the second working voltage values with the closest difference from the first mean, and calculates the second working voltage value of the m constant current source modules in the working state, and outputs said second working voltage as a second reference voltage value through the temperature detection module; and
the processing module calculates a difference between the first reference voltage value and the second reference voltage value as a temperature corrected voltage value.

2. The CMOS temperature compensator according to claim 1, wherein each first transistor further comprises a first electrode, a second electrode and a first control electrode, and each first switch unit comprises a first input terminal, a first output terminal and a first switching terminal; the second electrodes of the first transistors are respectively and electrically connected to the first input terminals which are connected in series with the first switch units; the first control electrodes of the first transistors are respectively and electrically connected to the bias control module, and the first electrodes are respectively and electrically connected to the first voltage module; and the first switching terminals of the first switch units are respectively and electrically connected to the sampling control module.

3. The CMOS temperature compensator according to claim 2, wherein the second transistor further comprises a third electrode, a fourth electrode and a second control electrode, and the third electrode is electrically connected to the first output terminals of the first switch units of the constant current source modules; and the second control electrode and the fourth electrode are electrically connected to the second voltage module.

4. The CMOS temperature compensator according to claim 3, wherein the temperature detection module has a terminal electrically connected to the third electrode terminal of the second transistor which is electrically connected to the first output terminals of the first switch units, for detecting a second working voltage value between the third electrode and the second control electrode.

5. The CMOS temperature compensator according to claim 3, wherein the processing module controls the sampling control module, so that the first transistors and the first switch units of the constant current source modules which are sequentially conducted with the second transistor, and the processing module controls the temperature detection module to sequentially detect and record the second working voltage value between the third electrode and the second control electrode of each second transistor when the first transistors are conducted with the second transistor.

6. The CMOS temperature compensator according to claim 1, wherein the temperature detection module comprises an analog-to-digital conversion unit, for converting an analog signal provided by the temperature detection module into the first reference voltage value and the second reference voltage value of a digital signal.

7. The CMOS temperature compensator according to claim 6, wherein the analog-to-digital conversion unit has a terminal electrically connected to a signal amplifier unit.

8. A sensing method using the CMOS temperature compensator according to claim 1, processed by the processing module, and comprising the steps of:
detecting a second working voltage value, wherein the processing module controls the sampling control module to set the first transistors and the corresponding first switch units to the conducting state in turn, and when the temperature detection module detects the second working voltage value of the second transistor when each constant current source module is in the working state;
calculating a first mean, wherein the processing module averages the second working voltage values corresponding to the constant current source modules in the working state to obtain the first mean;
obtaining a first reference voltage value, wherein the processing module calculates the difference between each second working voltage value and the first mean, and selects a value with the smallest difference between the second working voltage value and the first mean or a value with the first mean and outputs said value as the first reference voltage value through the temperature detection module;
obtaining a second reference voltage value, wherein the processing module selects the m constant current source modules with a voltage value closest to the first mean according to the difference between each second working voltage value and the first mean, and calculates the second working voltage values of the m constant current source modules in the working state and outputs said values as the second reference voltage value through the temperature detection module; and
obtaining a temperature corrected voltage value, wherein the processing module calculates and stores the difference between the first reference voltage value and the second reference voltage value as the temperature corrected voltage value.

9. The sensing method of a CMOS temperature compensator according to claim 8, further comprising the step of calculating temperature, wherein the processing module drives the temperature detection module to calculate the temperature detected by the second transistor according to the temperature corrected voltage value.
